(19) United States
(12) Patent Application Publication
(10) Pub. No.: US 2021/0103897 A1
(43) Pub. Date: Apr. 8, 2021

(54) APPARATUS, METHOD, AND PROGRAM PRODUCT FOR TASK-BASED CALENDAR ENTRY CREATION

(71) Applicant: LENOVO (Singapore) PTE. LTD., New Tech Park (SG)

(72) Inventor: Jonathan Lee, Cary, NC (US)

(21) Appl. No.: 16/595,254

(22) Filed: Oct. 7, 2019

(51) Int. Cl. G06Q 10/10; G06Q 10/06

(52) U.S. Cl. CPC G06Q 10/1097; G06Q 10/06316; G06Q 10/06314; G06Q 10/063118

(57) ABSTRACT

Apparatuses, methods, and program products are disclosed for task-based calendar entry creation. One apparatus includes a processor and a memory that stores code executable by the processor. The code is executable by the processor to detect, by use of the processor, a task to be completed. The code is executable by the processor to determine a priority corresponding to the task. The code is executable by the processor to communicate with a calendar application using a software interface to create a calendar entry on a calendar for the task based on the priority and an available time period on the calendar.

### BACKGROUND

### Field

The subject matter disclosed herein relates to electronic calendars and more particularly relates to task-based calendar entry creation.

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions. Electronic calendars may be used by an information handling device. Calendar entries in the electronic calendar may facilitate user efficiency.

### BRIEF SUMMARY

An apparatus for task-based calendar entry creation is disclosed. A method and computer program product also perform the functions of the apparatus. In one embodiment, the apparatus includes a processor and a memory that stores code executable by the processor. The code, in various embodiments, is executable by the processor to detect, by use of the processor, a task to be completed. The code, in certain embodiments, is executable by the processor to determine a priority corresponding to the task. The code, in some embodiments, is executable by the processor to communicate with a calendar application using a software interface to create a calendar entry on a calendar for the task based on the priority and an available time period on the calendar.

In some embodiments, the task is detected from a task list. In one embodiment, the task is detected by analyzing historical calendar entries, historical tasks, or a combination thereof. In various embodiments, the task is detected by analyzing a plurality of existing calendar entries. In some embodiments, the task corresponds to a deliverable for an existing calendar entry of the plurality of existing calendar entries.

A method for task-based calendar entry creation, in one embodiment, includes detecting, by use a processor, a task to be completed. In certain embodiments, the method includes determining a priority corresponding to the task. In some embodiments, the method includes communicating with a calendar application using a software interface to create a calendar entry on a calendar for the task based on the priority and an available time period on the calendar.

In some embodiments, the method includes receiving input indicating the priority. In various embodiments, the method includes receiving input indicating a length of time to complete the task. In one embodiment, detecting the task includes detecting the task from a task list. In some embodiments, detecting the task includes analyzing historical calendar entries, historical tasks, or a combination thereof. In certain embodiments, the method includes receiving information indicating that the task is complete.

In some embodiments, the method includes receiving information indicating to reschedule the task to a different time on the calendar. In various embodiments, detecting the task includes analyzing a plurality of existing calendar entries to determine the task. In certain embodiments, the task corresponds to a deliverable for an existing calendar entry of the plurality of existing calendar entries. In some embodiments, the method includes determining a user corresponding to the task. In various embodiments, the calendar corresponds to the user.

In one embodiment, a program product includes a computer readable storage medium that stores code executable by a processor. The executable code, in certain embodiments, includes code to perform detecting, by use a processor, a task to be completed. The executable code, in various embodiments, includes code to perform determining a priority corresponding to the task. The executable code, in some embodiments, includes code to perform communicating with a calendar application using a software interface to create a calendar entry on a calendar for the task based on the priority and an available time period on the calendar.

In certain embodiments, the executable code includes code to perform receiving input indicating the priority. In one embodiment, the executable code includes code to perform receiving input indicating a length of time to complete the task. In certain embodiments, the executable code includes code to perform receiving information indicating to reschedule the task to a different time on the calendar.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for task-based calendar entry creation;

FIG. 2 is a schematic block diagram illustrating one embodiment of an apparatus including an information handling device;

FIG. 3 is a schematic block diagram illustrating one embodiment of an apparatus including a task integration module;

FIG. 4 is a schematic block diagram illustrating another embodiment of an apparatus including a task integration module;

FIG. 5 is a schematic flow chart diagram illustrating an embodiment of a method for task-based calendar entry creation; and

FIG. 6 is a schematic flow chart diagram illustrating another embodiment of a method for task-based calendar entry creation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

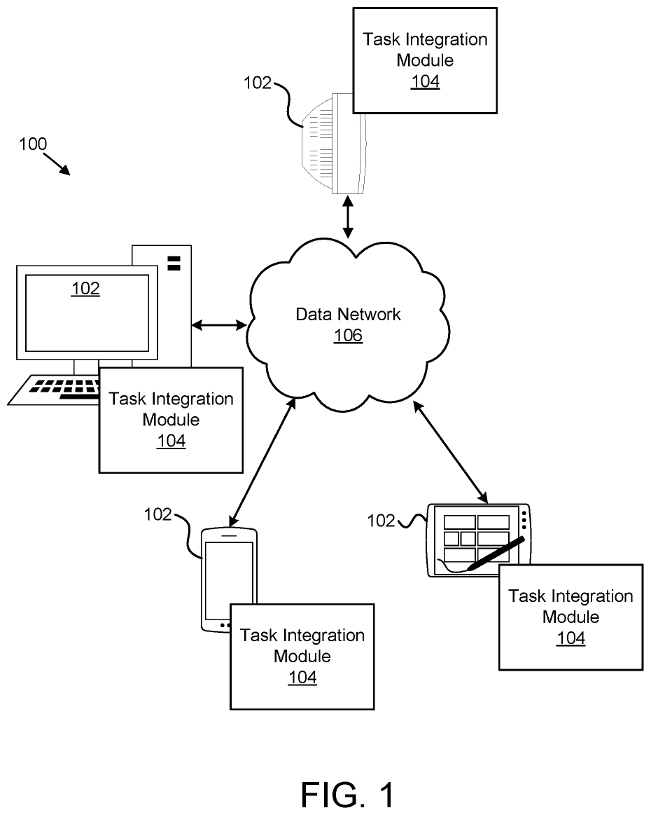

FIG. 1 depicts one embodiment of a system 100 for task-based calendar entry creation. In one embodiment, the system 100 includes information handling devices 102, task integration modules 104, and data networks 106. Even though a specific number of information handling devices 102, task integration modules 104, and data networks 106 are depicted in FIG. 1, one of skill in the art will recognize that any number of information handling devices 102, task integration modules 104, and data networks 106 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the task integration module 104. In certain embodiments, the task integration module 104 may detect, by use of a processor, a task to be completed. The task integration module 104 may also determine a priority corresponding to the task. The task integration module 104 may communicate with a calendar application using a software interface to create a calendar entry on a calendar for the task based on the priority and an available time period on the calendar. In this manner, the task integration module 104 may be used for task-based calendar entry creation.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

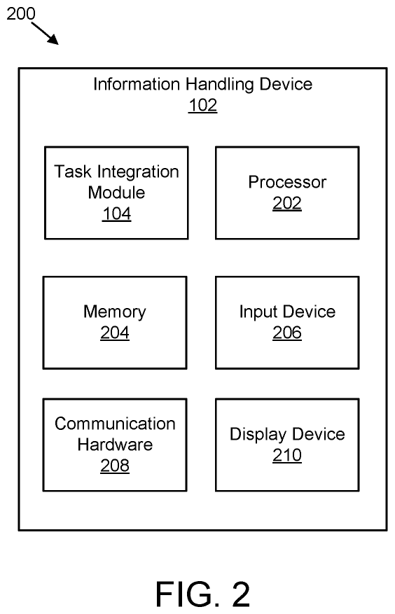

FIG. 2 depicts one embodiment of an apparatus 200 that may be used for task-based calendar entry creation. The apparatus 200 includes one embodiment of the information handling device 102. Furthermore, the information handling device 102 may include the task integration module 104, a processor 202, a memory 204, an input device 206, communication hardware 208, and a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the task integration module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RANI (“SDRAM”), and/or static RANI (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores tasks, task lists, calendars, and/or calendar entries. In some embodiments, the memory 204 also stores program code and related data, such as an operating system or other controller algorithms operating on the information handling device 102.

The information handling device 102 may use the task integration module 104 for task-based calendar entry creation. As may be appreciated, the task integration module 104 may include computer hardware, computer software, or a combination of both computer hardware and computer software. For example, the task integration module 104 may include circuitry, or the processor 202, used to detect, by use of the processor 202, a task to be completed. As another example, the task integration module 104 may include computer program code that determines a priority corresponding to the task. As a further example, the task integration module 104 may include computer program code that communicates with a calendar application using a software interface to create a calendar entry on a calendar for the task based on the priority and an available time period on the calendar.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the task integration module 104.

In some embodiments, it may be challenging to complete tasks in a task list because the tasks are not entered as calendar entries that allocate a time for the task to be completed. Described herein are various embodiments that use a task-based calendar entry creation technique to integrate tasks into calendar entries.

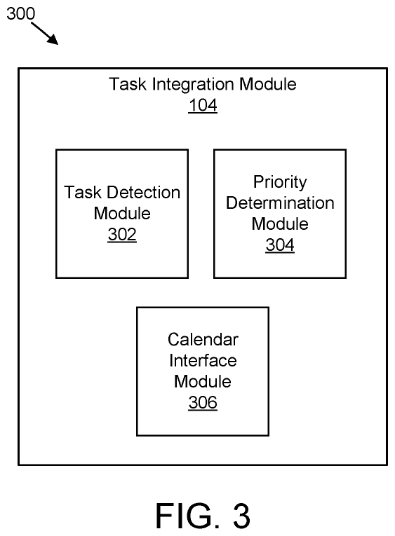

FIG. 3 depicts a schematic block diagram illustrating one embodiment of an apparatus 300 that includes one embodiment of the task integration module 104. Furthermore, the task integration module 104 includes a task detection module 302, a priority determination module 304, and a calendar interface module 306.

In certain embodiments, the task detection module 302 may detect (e.g., by use of a processor such as the processor 202), determine, find, retrieve, obtain, analyze, and/or receive, one or more tasks to be completed. As used herein, a task may be an item that requires some action or work to complete. In some embodiments, the task detection module 302 may detect the one or more tasks from a task list, a to-do list, a list of items to be completed, and so forth. The task detection module 302 may detect the one or more tasks and/or retrieve the one or more tasks for scheduling the one or more tasks.

In various embodiments, the task detection module 302 may detect the one or more tasks by analyzing historical calendar entries (e.g., calendar entries from time periods in the past), historical tasks (e.g., tasks that have already been completed), and/or emails. As may be appreciated, by analyzing historical calendar entries, historical tasks, and/or emails, the task detection module 302 may predict tasks that a user would like to complete in the future, thereby deriving predicted tasks for scheduling. In certain embodiments, the task detection module 302 may detect the one or more tasks by analyzing multiple existing calendar entries to determine the one or more tasks. In such embodiments, the one or more tasks may correspond to one or more deliverables for one or more existing calendar entries of the multiple existing calendar entries. For example, an existing calendar entry may be for a meeting in which a user is to make a presentation. The task detection module 302 may analyze the calendar entry for the meeting and determine that the user needs a task to prepare presentation materials. Thus, the task detection module 302 may create the task to prepare the presentation materials. As another example, an existing calendar entry may be for a trip for a user. The task detection module 302 may analyze the calendar entry for the trip and determine that the user needs to pack for the trip. Therefore, the task detection module 302 may create the task to pack for the trip. In a further example, the task detection module 302 may determine that one or more bills or expenses are coming due. Accordingly, the task detection module 302 may create a task to pay the one or more bills or expenses on or before their due dates. In such embodiments, if a confirmation of payment is received, the task detection module 302 may remove the task.

In one embodiment, the priority determination module 304 may determine a priority corresponding to one or more tasks. In certain embodiments, the priority determination module 304 may pose questions to a user to determine a prioritization of the one or more tasks. For example, the priority determination module 304 may request that a user indicate a high, medium, and/or low priority corresponding to each task of the one or more tasks. In some embodiments, the priority determination module 304 may predict a priority level based on prior completed tasks (e.g., similar tasks that have already been completed) and/or based on a date and/or time that the task was created. In another example, the priority determination module 304 may request that a user provide a numeric ranking of a priority of a list of tasks, an estimated time to complete each of the one or more tasks, a due date and/or time for the one or more tasks, one or more users assigned to the one or more tasks, and/or other items that may be used to identify a priority for the one or more tasks.

In various embodiments, the calendar interface module 306 may communicate with a calendar application using a software interface to create a calendar entry on a calendar for the task based on the priority and an available time period (e.g., unscheduled time period, open time period, a time period without another item scheduled) on the calendar. In other words, the calendar interface module 306 schedules the one or more tasks on the user's calendar during available time slots to facilitate completion of the one or more tasks. This is beneficial because traditional task lists do not dynamically schedule the tasks onto a calendar to facilitate completion of the tasks at a specific date and/or time. As may be appreciated, the calendar interface module 306 may take into consideration when the one or more tasks need to be completed by (e.g., date and/or time), a length of time to complete the one or more tasks, prerequisites for the one or more tasks (e.g., tasks and/or events that need to occur before a task can be completed), a budget for the one or more tasks, whether multiple people are needed for a task (e.g., analyzing multiple calendars together and/or scheduling the task on multiple people's calendars), and/or other factors.

By using the task integration module 104, tasks may be integrated into a user's calendar into free and/or available time slots automatically, without the user adding them to the calendar. The task integration module 104 may space the task calendar entries over a time period so that the user has free and/or available time slots still in their calendar for unplanned items. In some embodiments, a single task may occupy multiple calendar entries.

In certain embodiments, the task integration module 104 may receive information indicating that the task is complete (e.g., a check box within the calendar entry may be used to indicate that the task calendar entry is complete, or a menu selection item may be available to mark that the task calendar entry is complete). In such embodiments, if the task is indicated as being complete in the calendar, the calendar may transmit information to the task list so that the task in the task list is marked as complete. Furthermore, if a task in the task list is marked as completed, the task list may transmit information to the calendar to remove the calendar entry from the user's calendar. Thus, the task list software and the calendar software may be work together to facilitate user interaction between the calendar software and the task list software. In addition to a link between the task list software and the calendar software for completion of tasks, the task list software and the calendar software may be coordinated to handle adding tasks, removing tasks, changing a priority of tasks, changing a due date and/or time for tasks, and so forth.

In some embodiments, the task integration module 104 may receive information indicating to reschedule the task to a different time on the calendar. For example, a user may have been unable to begin the task at the scheduled time and/or a user may not have been able to finish the task in the allocated time. The user may provide input to the task integration module 104 so that the rescheduled time for the task has the correct time and/or priority allocated. In various embodiments, the task integration module 104 may determine a user corresponding to one or more tasks. In such embodiments, the calendar that is updated corresponds to the user. For example, a task list may be used for multiple users. Each task in the task list may indicate one or more users that the task is assigned to. The calendar or calendars that add an entry for a task correspond to the one or more users that the task is assigned to.

In certain embodiments, the task integration module 104 may use artificial intelligence powered software for the task detection module 302, the priority determination module 304, and/or the calendar interface module 306. In various embodiments, the calendar software used by the task integration module 104 and/or the task list software may be compatible with plug-ins to facilitate interoperability between the calendar software and the task list software. In some embodiments, the task integration module 104 may access the calendar software and the task list software concurrently to facilitate interoperability. In certain embodiments, the task integration module 104 may implement machine learning features to make decisions based on previous and/or historical behaviors.

In various embodiments, the task integration module 104 may create recurring tasks based on historical information (e.g., for expense reporting, check-ins, status calls, checking email, responding to email, leaving for work, dropping kids off, and so forth). In some embodiments, the task integration module 104 may integrate the task list software with one or more of a calendar software, a smart display, a voice activated device, and/or reminder devices to facilitate task completion.

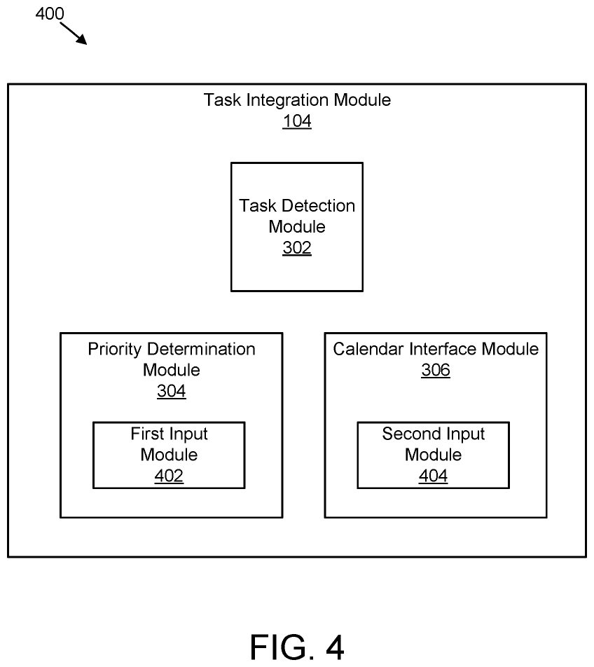

FIG. 4 is a schematic block diagram illustrating another embodiment of an apparatus 400 that includes one embodiment of the task integration module 104. Furthermore, the task integration module 104 includes one embodiment of the task detection module 302, the priority determination module 304, and the calendar interface module 306, that may be substantially similar to the task detection module 302, the priority determination module 304, and the calendar interface module 306 described in relation to FIG. 3. The priority determination module 304 includes a first input module 402 and the calendar interface module 306 includes a second input module 404.

The first input module 402 may receive input indicating a priority. The priority indication may be a numeric list, a due date and/or time, a priority level (e.g., high, medium, low, critical, urgent, etc.), and/or other inputs. In various embodiments, the priority may be predicted based on previous tasks and/or by a due date and/or time. In some embodiments, the first input module 402 may receive the input by data entry, voice, and/or digital means.

The second input module 404 may receive input indicating a length of time to complete the task. The length of time to complete the task may include a due date and/or time, a number of users that will facilitate completing the task, and/or other information. In some embodiments, the second input module 404 may receive the input by data entry, voice, and/or digital means.

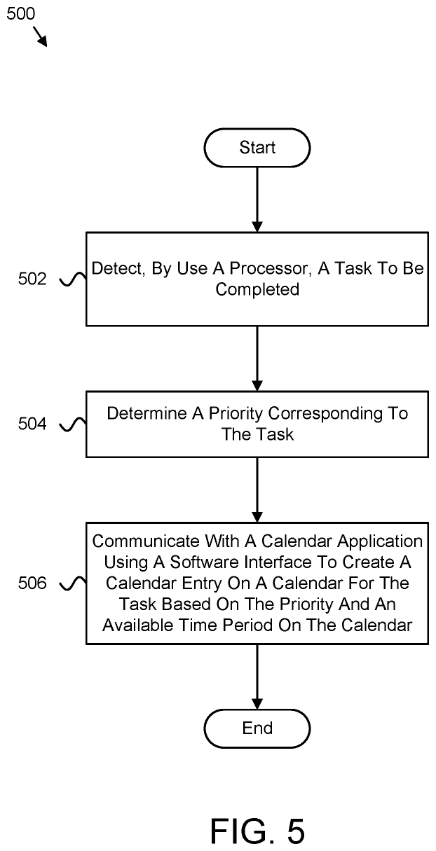

FIG. 5 is a schematic flow chart diagram illustrating an embodiment of a method 500 for task-based calendar entry creation. In some embodiments, the method 500 is performed by an apparatus, such as the information handling device 102. In other embodiments, the method 500 may be performed by a module, such as the task integration module 104. In certain embodiments, the method 500 may be performed by a processor executing program code, for example, a microcontroller, a microprocessor, a CPU, a GPU, an auxiliary processing unit, a FPGA, or the like.

The method 500 may include detecting 502, by use of a processor (e.g., the processor 202), a task to be completed. In certain embodiments, the task detection module 302 may detect 502 the task to be completed. In various embodiments, detecting 502 the task includes detecting the task from a task list. In some embodiments, detecting 502 the task includes analyzing historical calendar entries and/or historical tasks. In one embodiment, detecting 502 the task includes analyzing a plurality of existing calendar entries to determine the task. In certain embodiments, the task corresponds to a deliverable for an existing calendar entry of the plurality of existing calendar entries.

The method 500 may include determining 504 a priority corresponding to the task. In some embodiments, the priority determination module 304 may determine 504 the priority corresponding to the task.

The method 500 may include communicating 506 with a calendar application using a software interface to create a calendar entry on a calendar for the task based on the priority and an available time period on the calendar, and the method 500 may end. In some embodiments, the calendar interface module 306 may communicate 506 with the calendar application using the software interface to create the calendar entry on the calendar for the task based on the priority and the available time period on the calendar.

In various embodiments, the method 500 may include receiving input indicating the priority. In some embodiments, the method 500 may include receiving input indicating a length of time to complete the task.

In certain embodiments, the method 500 may include receiving information indicating that the task is complete. In one embodiment, the method 500 may include receiving information indicating to reschedule the task to a different time on the calendar.

In some embodiments, the method 500 may include determining a user corresponding to the task. In various embodiments, the calendar corresponds to the user.

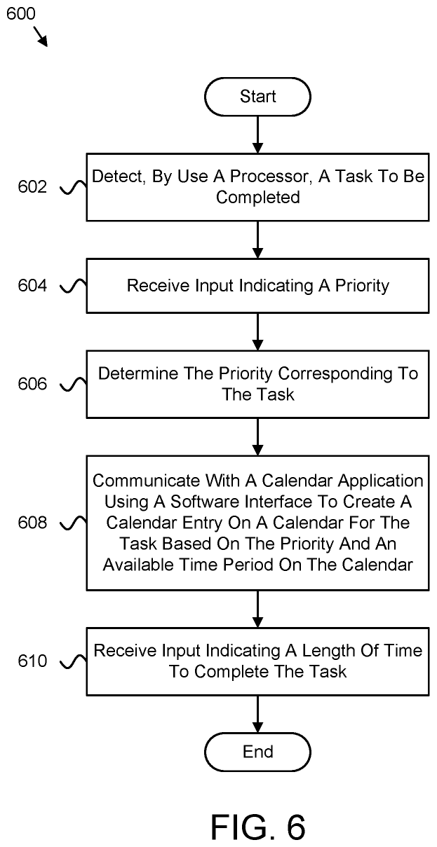

FIG. 6 is a schematic flow chart diagram illustrating another embodiment of a method 600 for task-based calendar entry creation. In some embodiments, the method 600 is performed by an apparatus, such as the information handling device 102. In other embodiments, the method 600 may be performed by a module, such as the task integration module 104. In certain embodiments, the method 600 may be performed by a processor executing program code, for example, a microcontroller, a microprocessor, a CPU, a GPU, an auxiliary processing unit, a FPGA, or the like.

The method 600 may include detecting 602, by use of a processor (e.g., the processor 202), a task to be completed. In certain embodiments, the task detection module 302 may detect 602 the task to be completed. In various embodiments, detecting 602 the task includes detecting the task from a task list. In some embodiments, detecting 602 the task includes analyzing historical calendar entries and/or historical tasks. In one embodiment, detecting 602 the task includes analyzing a plurality of existing calendar entries to determine the task. In certain embodiments, the task corresponds to a deliverable for an existing calendar entry of the plurality of existing calendar entries.

The method 600 may include receiving 604 input indicating a priority. In various embodiments, the first input module 402 may receive 604 the input indicating the priority.

The method 600 may include determining 606 the priority corresponding to the task. In some embodiments, the priority determination module 304 may determine 606 the priority corresponding to the task.

The method 600 may include communicating 608 with a calendar application using a software interface to create a calendar entry on a calendar for the task based on the priority and an available time period on the calendar. In some embodiments, the calendar interface module 306 may communicate 608 with the calendar application using the software interface to create the calendar entry on the calendar for the task based on the priority and the available time period on the calendar.

The method 600 may include receiving 610 input indicating a length of time to complete the task, and the method 600 may end. In various embodiments, the second input module 404 may receive 610 the input indicating the length of time to complete the task.

In certain embodiments, the method 600 may include receiving information indicating that the task is complete. In one embodiment, the method 600 may include receiving information indicating to reschedule the task to a different time on the calendar.

In some embodiments, the method 600 may include determining a user corresponding to the task. In various embodiments, the calendar corresponds to the user.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
detect, by use of the processor, a task to be completed;
determine a priority corresponding to the task; and
communicate with a calendar application using a software interface to create a calendar entry on a calendar for the task based on the priority and an available time period on the calendar.

2. The apparatus of claim 1, wherein the task is detected from a task list.

3. The apparatus of claim 1, wherein the task is detected by analyzing historical calendar entries, historical tasks, or a combination thereof.

4. The apparatus of claim 1, wherein the task is detected by analyzing a plurality of existing calendar entries.

5. The apparatus of claim 4, wherein the task corresponds to a deliverable for an existing calendar entry of the plurality of existing calendar entries.

6. A method comprising:
detecting, by use a processor, a task to be completed;
determining a priority corresponding to the task; and
communicating with a calendar application using a software interface to create a calendar entry on a calendar for the task based on the priority and an available time period on the calendar.

7. The method of claim 6, further comprising receiving input indicating the priority.

8. The method of claim 6, further comprising receiving input indicating a length of time to complete the task.

9. The method of claim 6, wherein detecting the task comprises detecting the task from a task list.

10. The method of claim 6, wherein detecting the task comprises analyzing historical calendar entries, historical tasks, or a combination thereof.

11. The method of claim 6, further comprising receiving information indicating that the task is complete.

12. The method of claim 6, further comprising receiving information indicating to reschedule the task to a different time on the calendar.

13. The method of claim 6, wherein detecting the task comprises analyzing a plurality of existing calendar entries to determine the task.

14. The method of claim 13, wherein the task corresponds to a deliverable for an existing calendar entry of the plurality of existing calendar entries.

15. The method of claim 6, further comprising determining a user corresponding to the task.

16. The method of claim 15, wherein the calendar corresponds to the user.

17. A program product comprising a computer readable storage medium that stores code executable by a processor, the executable code comprising code to perform:
detecting, by use a processor, a task to be completed;
determining a priority corresponding to the task; and
communicating with a calendar application using a software interface to create a calendar entry on a calendar for the task based on the priority and an available time period on the calendar.

18. The program product of claim 17, wherein the executable code comprises code to perform receiving input indicating the priority.

19. The program product of claim 17, wherein the executable code comprises code to perform receiving input indicating a length of time to complete the task.

20. The program product of claim 17, wherein the executable code comprises code to perform receiving information indicating to reschedule the task to a different time on the calendar.
